(19) United States
(12) Patent Application Publication
(10) Pub. No.: US 2013/0227938 A1
(43) Pub. Date: Sep. 5, 2013

(54) HYDROSTATIC ENERGY STORE

(71) Applicants: Matthias Mueller, Langenau (DE); Peter Schmuttermair, Gessertshausen (DE)

(72) Inventors: Matthias Mueller, Langenau (DE); Peter Schmuttermair, Gessertshausen (DE)

(73) Assignee: ROBERT BOSCH GMBH, Stuttgart (DE)

(21) Appl. No.: 13/695,931

(22) PCT Filed: Feb. 25, 2011
(86) PCT No.: PCT/EP11/00940

§ 371 Date: May 21, 2013

(30) Foreign Application Priority Data
May 5, 2010 (DE) 10 2010 019 434.4

(51) Int. Cl. F15B 15/00

(52) U.S. Cl. CPC F15B 15/00
USPC 60/327; 60/325

(57) ABSTRACT

A drive includes a hydraulic machine configured to convert kinetic energy into hydraulic energy and a hydrostatic energy store configured to be charged by the hydraulic machine. The drive further includes a control device configured to control the preloading of the store as a function of an operating state of a device driven by the drive. A hydrostatic energy store for a drive of a device includes a hydraulic machine which converts kinetic energy into hydraulic energy and charges the store. The store further includes a control device configured to vary a preloading of the store as a function of an operating state of the device. A method for adapting a preloading of a hydrostatic energy store includes determining an operating state of the device, determining the optimum preloading as a function of the determined operating state, and setting the preloading. A control device controls the setting of the preloading.

The invention concerns a drive with a hydrostatic energy store according to the preamble of claim 1, a hydrostatic energy store according to the preamble of claim 14 and a method for adapting a preload of a hydrostatic energy store according to the preamble of claim 15.

Such drives are provided in particular as traction drives of vehicles or as drives for machines which are braked and accelerated frequently. A hydromachine, working as a pump and coupled to the drive at a suitable point, applies a braking moment to brake the machine or vehicle by delivering a pressure medium into a pressure medium chamber of a hydrostatic energy store against a pressure predominating in the store. This firstly relieves the load on a conventional e.g. mechanical brake. Secondly the stored braking energy can be recuperated at a later time to accelerate the machine or vehicle. The energy is stored, depending on the selected loading type of the store, either in the form of potential energy of a mass, in the form of elastic spring work or in the form of volume-changing work of a compressible fluid, in particular a gas.

One particularly important operating parameter of the store is a preload with which the pressurized medium chamber is pressurized. The minimum pressure in the pressure medium chamber, against which a pressure medium must be delivered into the store, can be adjusted via the selected amount of the preload. Also the maximum quantity of energy which can be accumulated in the store depends decisively on the amount of preload.

DE 102006042390 A1 discloses a drive with energy storage device and a method for storing kinetic energy.

The drive is coupled to an adjustable hydraulic piston machine and a hydrostatic energy store of the drive is charged via the piston machine on braking. A pressure predominating in the store here determines a maximum braking moment which can be generated by the piston machine. To adjust or increase the braking moment when required, an adjustable choke point is provided between the piston machine and the store. The greater the choking selected, the stronger the braking moment which the piston machine can deliver. A control unit determines the required choke setting from the required braking moment, the pressure in the store and a pump swivel angle. The disadvantage here is that hydraulic energy of the pressure medium is converted into heat loss at the choke point. The quantity of energy which can potentially be recuperated for the drive is thus restricted. A further disadvantage is that the preload of the store cannot be changed during operation and no optimization of the preload to the demand of the drive or its braking is provided.

DE 102006019672 A1 discloses a hydrostatic energy store and a method for storing kinetic energy of a drive in which the preload of the store can be changed. This is achieved via a control unit as a function of a temperature of the pressure medium or a fill level of a pressure medium reservoir. The aim is to prevent an exceedance of a critical maximum operating pressure of the store. The disadvantage here is that the control unit determines the preload only as a function of safety-relevant status values of the store and no optimization of the preload oriented to the needs of the drive or its brake is provided.

The object of the present drive, the hydrostatic energy store and the method for adapting a preload according to the invention is to store energy efficiently and adapted to the needs of a device driven by a drive.

This object is achieved by a drive with the features of claim 1, by a hydrostatic energy store with the features of claim 14 and by a method with the features of claim 15.

The drive according to the invention has a hydrostatic energy store which can be charged by means of a hydromachine for converting kinetic energy into hydraulic energy. Also it has a control device which is designed such that a preload of the hydrostatic store can be changed as a function of an operating state of a device driven by the drive. The control device is advantageously oriented to the operating states essential for the device and hence to the needs of the device. The hydromachine is coupled to the drive and in overrun operation of the device can work as a hydropump in order to charge the store with a hydraulic pressure medium up to a hydraulic operating pressure p. At the same time this brakes the device, whereby in braking mode the load on conventional brakes of the device is relieved, minimizing the wear thereon. One great advantage is that here the kinetic energy of the device, for example a vehicle, is converted into hydraulic energy via the hydromachine working as a pump and is stored recoverably in the store. Particularly preferably a drive according to the invention is used as a traction drive in a vehicle which performs frequent braking and start-up maneuvers. Examples are agricultural machines, trucks, collection vehicles or refuse collection vehicles. The hydromachine is preferably formed as an axial piston machine in sloping plate or sloping axis design. Said designs, via a swivel angle of the sloping plate or sloping axis, allow simple regulation of the delivery flow of the pressure medium into the store and hence simple control of the braking effect of the hydromachine. As the amount of the preload of the store has a substantial influence on the energy quantity which can be accumulated in the store and the maximum braking effect of the pump, it is of great advantage to influence this via the control device oriented to the needs of the device. For refuse collection vehicles for example, “city driving” or “collection driving” constitute particular operating states and hence a particular need of the vehicle.

The equation of the kinetic energy, to be stored in hydraulic form in the store, of a vehicle of mass m and speed v is:

E₁₂=ηᵣₑₖ½mv²

wherein ηᵣₑₖ is the store efficiency and for example is around 50%. For city driving with speed v of up to 50 km/h, in contrast to collection driving with a speed of around 15 km/h, the vehicle has around ten times more kinetic energy to be stored insofar as the vehicle is braked to v=0 km/h. The converse applies to the braking moments. The braking moments required during collection driving are found from experience to be significantly higher than in city driving, since collection must take place work-efficiently and the drivers therefore perform strong braking as well as strong acceleration. The operating state “city driving” for the refuse collection vehicle used as an example is therefore characterized by a large quantity of kinetic energy to be stored and by moderate braking moments. Collection driving however is characterized by a low quantity of kinetic energy to be stored and by high braking moments. According to the invention the preload can be changed via the control device at any time in operation of the device. Also the change in preload can be made not only in relation to a present operating state but also for a future operating state. The present or future operating state can be determined manually by operating personnel of the device, for example by a switch (refuse collection vehicle: switch collection driving [symbol] city driving) or in that the control device for example detects a working device activated by the operating personnel and from this determines the operating state (refuse collection vehicle: activated superstructure hydraulics collection driving). Also automatic determination of the operating state is possible independently of the operating personnel, in that the control device for example evaluates the development of the speed or acceleration of the device or drive. In vehicles, the control device can evaluate data from a navigation system, for example a road type or a height profile of a present or planned route, and from this determine the present or future operating state of the vehicle. It is also advantageous if the control device determines a vehicle weight. From the operating state of the device or vehicle determined in this way, the control device can determine or calculate the optimum preload of the store and set this by controlling corresponding assemblies.

Advantageous refinements of the invention are the subject of further subclaims.

In order to recuperate again the hydraulic energy stored in the store, the store can be discharged via the hydromachine. This then works as a hydromotor. The advantage here is that via the coupling of the hydromachine with the drive of the device, on discharge the kinetic energy of the device is increased again or the device or vehicle accelerated. The control unit here allows the hydraulic discharge of the store to be interrupted at a lower operating pressure p₁ predominating in the pressure medium chamber of the store. The pressure p₁ is preferably selected such that a sufficient braking moment is available for a subsequent braking of the device or drive typical of the operating state.

In a further refinement the energy from the store can be made available at least partly to other consumers of the device, such as for example hydraulic drives of working devices of a truck.

It is of particular advantage if the preload of the store is provided by a compressible fluid or gas arranged in a gas chamber of the store under high pressure, i.e. if the store is gas-loaded and is formed as a hydropneumatic store. In this case the preload is the pretension pressure p₀ of the gas in the gas chamber of the store. The change in preload then takes place by a change of a pressure p of the compressible fluid or gas. The formula for a maximum energy amount E₁₂ which can be stored in the hydropneumatic store between two states 1 and 2 illustrates the great influence of the gas pretension pressure p₀:

$${E}_{12} = \frac{{p}_{0} {V}_{o}}{n - 1} [ {( \frac{{p}_{2}}{{p}_{1}} )}^{\frac{( n - 1 )}{n}} - 1 ]$$

p₀: gas pretension pressure in the gas chamber with unfilled pressure medium chamber;

V₀: effective gas volume in the gas chamber with unfilled pressure medium chamber;

p₁: lower operating pressure in the gas chamber at the start of the storage process;
p₂: upper operating pressure in the gas chamber at the end of the storage process;
n: polytropic exponent, value between 0 and 1.4.

The lower operating pressure p₁ of the gas is preferably around 10% higher than p₀. A pressure ratio p₂/p₀ is preferably less than 3. The pretension pressure p₀ therefore establishes the pressure level of the store and the upper and lower operating pressures p₂ and p₁. Also the maximum braking moment which can be generated by the hydromachine with unfilled pressure medium chamber depends decisively on the pretension pressure p₀:

$${M}_{braking , ma x , {p}_{0}} = i \frac{{V}_{g ma x} {p}_{o}}{2 π {η}_{hm , pump} ( {p}_{o} , {n}_{pump} , {V}_{g} )}$$

A high pretension pressure p₂ therefore proves advantageous when an operating state requires firstly a high braking moment M_{braking}, but secondly however the energy to be stored in the store is relatively low (e.g. on collection travel of a refuse collection vehicle at 15 km/h). If no such high braking moment is required and the energy quantity to be stored is higher, a lower pretension pressure is advantageous (e.g. on city driving of a refuse collection vehicle at km/h). The technical conversion for providing the preload via a pressurized gas takes place by means of hydropneumatic stores in piston, bubble or membrane storage design. Alternatively hydropneumatic stores are also conceivable without a separating element between the gas and the pressure medium. As an alternative to preload by a pressure force of the gas, on use of alternative store designs preloads are possible by the force of gravity or a spring.

In a preferred refinement of the invention the store is connected via a hydraulic high-pressure line to a working line of a hydraulic circuit of the drive and can be isolated from the hydraulic circuit of the drive via a shut-off valve arranged in the hydraulic high-pressure line. Thus it is possible to operate the hydraulic drive also without regenerative storage of kinetic energy.

Advantageously the control device is connected with a pressure sensor or other pressure determination device which determines the current pressure p of the fluid or gas in the store. The current pressure p is an operating parameter which is required by the control unit to determine an optimum preload or optimum pretension pressure p₀.

In a preferred refinement of the drive according to the invention, the pressure of the fluid or gas in the store can be increased as required via a compressor unit. For a given fill level of the pressure medium chamber of the store, this allows the current operating pressure p of the store to be increased. In this way indirectly also the pretension pressure p₀, i.e. the fluid or gas pressure in the empty or evacuated pressure medium chamber of the store can be increased. Consequently higher braking moments M_{braking} and storable energy amounts E₁₂ are conceivable.

In a further preferred refinement of the drive according to the invention, the pressure of the fluid or gas can be reduced as required via a pressure-relief unit. For a given fill level of the pressure medium chamber of the store, this allows the current operating pressure p to be reduced. In this way the pretension pressure p₀ is also reduced indirectly. The entire hydropneumatic system is then subjected to a lower operating pressure p and less load to meet the requirements.

In a preferred variant the compressor unit has a pump which is connected via a pneumatic low-pressure line with a gas tank and via a pneumatic high-pressure line with the gas chamber of the store. The pump can deliver gas to the gas chamber and thus in the manner shown increase the pressure p or indirectly the pretension pressure p₀. The pressure p can be increased rapidly and continuously by means of continuous working of the pump. Instead of a pump, a conventional compressor or other gas compressor can be used.

In a technically simple embodiment example of the device, the pressure-relief unit of the drive has a shut-off valve which is connected via a pneumatic low-pressure line with a gas tank and via a pneumatic high-pressure line with the gas chamber of the store.

In addition to a connection with the pressure sensor of the store, the control device can have further connections with the shut-off valve of the hydraulic high-pressure line or with the hydromachine or with a drive of the pump or with the shut-off valve of the pressure-relief unit. The control unit can thus, in a manner adapted to the needs of the operating state determined, increase or reduce the pretension pressure via the said assemblies. Also the control device can if necessary isolate the hydromachine from the store or adapt the delivery power of the hydromachine.

In a further preferred refinement, the drive of the pump is a hydraulic motor which has a high-pressure connection connected with the hydraulic high-pressure line. Thus regeneratively stored braking energy of the device or vehicle can be recuperated to compress the gas or finally to increase the pretension pressure. This contributes further to an increase in efficiency of the drive.

Here it is generally advantageous if a shut-off valve which can be controlled by the control device is arranged in a line connecting the hydraulic motor and the hydraulic high-pressure line.

In a further advantageous variant of the drive, the compressor unit has a hydropneumatic pressure booster, wherein a hydraulic chamber of the pressure booster is connected via a 3/2-way valve, depending on its switch position, with a tank or with a hydraulic high-pressure line of the store, and wherein a gas chamber of the pressure booster is connected via a 3/2-way valve, depending on its switch position, with a gas tank or with a pneumatic high-pressure line of the store.

A hydrostatic energy store according to the invention for a drive of a device, in particular for a traction drive of a vehicle, to convert kinetic energy into hydraulic energy, has a hydromachine which can charge the store. Via a control device of the store, a preload of the store can be changed as a function of an operating state of the device. The control system is thus oriented to the needs of the device. The store is coupled to the drive and in overrun operation of the device can be charged via a hydromachine with a hydraulic pressure medium up to an operating pressure p. At the same time this brakes the device, whereby in braking mode the load on conventional brakes of the device is relieved, minimizing the wear thereon. The kinetic energy of the device, for example a vehicle, can thus be converted into hydraulic energy via the hydromachine working as a pump and stored recoverably in the store. Particularly preferably a store according to the invention is used in a vehicle which performs frequent braking and start-up maneuvers. Examples are agricultural machines, trucks, collection vehicles or refuse collection vehicles. As the amount of the preload of the store has a substantial influence on the energy quantity which can be accumulated in the store and the maximum braking effect of the hydromachine, it is of great advantage to influence this via the control device. Further aspects and advantages of the store according to the invention are described with reference to claim 1.

A method according to the invention for adapting a preload of a hydrostatic energy store of a drive of a device, in particular a traction drive of a vehicle, has the following steps: determining an operating state of the device; determining the optimum preload as a function of the operating state determined; setting the preload. At least the step of setting the preload is here controlled by a control device. The object of the method according to the invention for adapting a preload which allows efficient storage of kinetic energy adapted to the needs of the device driven by the drive, is thus achieved. One method of adapting the preload also comprises allowing discharge of the store to various minimum pressure levels as a function of the operating state and a braking typical thereof.

Three embodiment examples of the invention are described in more detail below with reference to schematic drawings. These show:

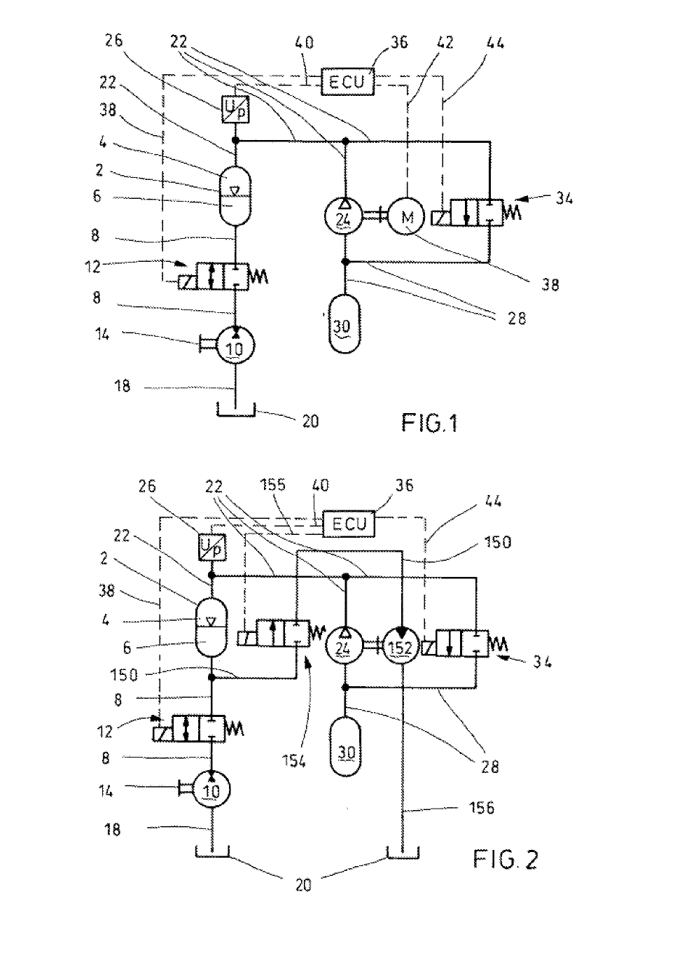

FIG. 1 an extract of a hydraulic circuit diagram of a first embodiment example of a traction drive according to the invention;

FIG. 2 an extract of a hydraulic circuit diagram of a second embodiment example of a traction drive according to the invention;

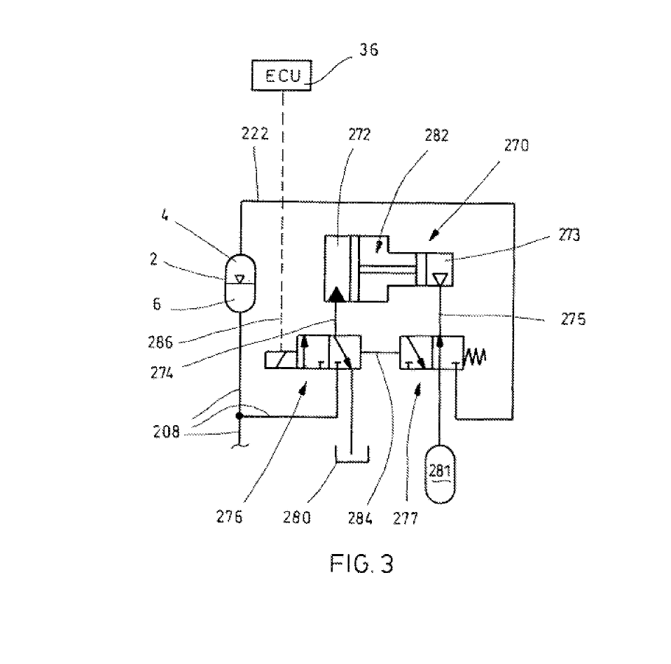

FIG. 3 an extract of a hydraulic circuit diagram of a second embodiment example of the traction drive according to the invention with an alternative compressor unit.

FIG. 1 shows an extract of a hydraulic circuit diagram of a first embodiment example of a drive according to the invention, designed as a traction drive, which allows regenerative braking and acceleration. A hydrostatic energy store according to the invention, formed as a hydropneumatic membrane store 2, has a gas chamber 4 and a pressure medium chamber 6. The two chambers 4, 6 are separated via a deformable and correspondingly mobile membrane. The same pressure p therefore acts in both chambers.

The pressure medium chamber 6 of the store 2 is connected via a hydraulic high-pressure line 8 to an axial piston machine 10 in sloping plate design. A 3/2-way shut-off valve 12 is arranged in the hydraulic high-pressure line 8 between the store 2 and the axial piston machine 10. The axial piston machine 10 is connected via a coupling 14 to a wheel or to a set of wheels of a vehicle (not shown). A tank 20 filled with hydraulic pressure medium is connected to a low-pressure connection of the axial piston machine 10 via a low-pressure line 18.

A pneumatic high-pressure line 22 is connected to the gas chamber 4. Via this line, the gas chamber 4 is connected with a high-pressure connection of a pump 24. A pressure sensor 26 is connected to the high-pressure line 22 to determine the pressure p in the store. A low-pressure connection of the pump 24 is connected with a gas tank 30 via a pneumatic low-pressure line 28. The pump 24 is connected to a motor 32 and is driven thereby.

In parallel to the pump 24, a 2/2-way shut-off valve 34 is connected to a branch of the pneumatic high-pressure line 22 and to a branch of the pneumatic low-pressure line 28.

A control device 36 is connected via a control signal line 38 with a control system (not shown) of the drive which controls the shut-off valve 12 and the axial piston machine 10. Furthermore the control device 36 is connected via the control-signal line 40 with the pressure sensor 26, via the control-signal line 42 with the motor 32 and via the control-signal lines 44 with the shut-off valve 34. Also the control device 36 is connected via a signal line with a fill-level sensor (neither shown) to determine the fill level of the pressure medium in the store 2. The control device 36 receives information from the drive control system on the current operating state of the vehicle, such as for example the speed, whether braking is required, what braking moment is required, whether acceleration is required, how great that acceleration should be, how heavy the vehicle is, etc. Conversely the control device 36 controls the drive control system which in turn controls the shut-off valve 12 and the axial piston machine 10.

During operation and at the start of braking, the shut-off valves 12 and 34 are closed. The control device 36 matches the information from the control system with the pressure p determined by the pressure sensor 26 and the fill level determined by the fill-level sensor and determines whether pressure p or a corresponding gas pretension pressure p₀ is sufficiently high to provide a required braking moment from the sole braking effect of the axial piston machine 10 working as a pump. It also determines whether a free gas volume of the store 2 is sufficient to be able to store the kinetic energy of the vehicle completely.

If the pressure p is sufficiently high and if the free gas volume in the store is sufficient, the braking process can take place completely regeneratively. The control device 36 passes the information to the drive control system to open the shut-off valve 12. The control system opens the shut-off valve 12 and thus connects the high-pressure connection of the axial piston machine 10 with the pressure medium chamber 6 of the store 2 via the hydraulic high-pressure line 8. At the same time the control device 36 calculates a swivel angle of the sloping plate of the axial piston machine adapted to the required braking moment, transmits this to the control system (not shown) which controls the axial piston machine 10 accordingly. The axial piston machine 10 thus works as a pump for the braking period and delivers pressure medium from the tank 20 against pressure p into the store 2. Since during braking pressure p rises because of the pressure medium volume delivered into the store 2, the control device 36 continuously adjusts the swivel angle of the sloping plate via the control system in order thus to adapt the braking moment. Alternatively, and in energy terms less usefully however, the shut-off valve 34 can be opened by the control device 36 in order to maintain the pressure p in the store 2 and hence the braking moment constant by escape of gas.

If the required braking moment is to be provided regeneratively or exclusively by the axial piston machine 10 working as a pump, and the pressure p or its corresponding gas pretension pressure p₀ is not sufficient even at maximum swivel angle of the axial piston machine 10, the gas pressure or the pressure p in the store must be increased via the pump 24. The shut-off valve 34 is then closed. From the data from the control system, the control device 36 determines the required pressure p in the store 2 and controls the motor 32 of the pump 24 accordingly. From a gas tank 30 under suitable pretension, the pump 24 delivers gas—generally nitrogen—into the gas chamber 4 of the store 2. During braking the control device 36 permanently matches the value p measured by pressure sensor 26 against the information from the control system, i.e. for example the required braking moment and the swivel angle of the axial piston machine 10, and determines whether the pump 24 must continue to deliver gas into the gas chamber 4.

A similar case, in which the pressure p or its corresponding gas pretension pressure p₀ must be increased, occurs if for example a refuse collection vehicle switches from operating state “city driving” into operating state “collection driving”. The driver selects the operating state “collection driving” for example via a switch. The control unit 36 determines the optimum gas pretension pressure p₀, which must be higher than in city driving since higher braking moments are required. The control device 36 then controls the motor 32 of the pump 24 via the signal line 42 so that gas is delivered from the gas tank 30 to the gas chamber 4 of the store 2 until the pressure p corresponding to the necessary pretension pressure p₀ is achieved in the store 2.

When the pressure p of the store 2 or its corresponding gas pretension pressure p₀ is not sufficiently high, the braking moment of the axial piston machine 10—as an alternative to the solutions outlined above—can be supplemented by the conventional brakes of the vehicle. The pressure p need not then be increased. The same applies to the case where the free gas volume in the store 2 is not sufficient to absorb completely the entire kinetic energy of the vehicle.

The energy accumulated in the store 2 can be recuperated for an acceleration process of the vehicle. At the start of the acceleration process the shut-off valves 12 and 34 are closed. The drive control system transmits the information of an acceleration moment required by the driver via the signal line 38 to the control device 36. The latter determines whether the pressure p predominating in the store 2 or its corresponding gas pretension pressure p₀ is sufficient for the required acceleration moment. The drive control system opens the shut-off valve 12 and transmits a corresponding value for the swivel angle to be set to the axial piston machine 10. The pressure medium is then present via the hydraulic pressure line 8 at the high-pressure connection of the axial piston machine 10, is expanded thereby in a low-pressure line 18 and finally flows into the tank 20. On the acceleration process therefore the axial piston machine 10 works as a motor and drives a wheel or several wheels (not shown) via the coupling 14. The extraction of pressure medium from the pressure medium chamber 6 of the store 2 causes the pressure p in the store 2 to fall. The energy recuperation or evacuation of the hydraulic pressure medium chamber 6 can be disconnected at a defined pressure p, adapted to the amount of the expected future braking moments of continued travel.

Thus it is ensured via the control device 36 that the pressure p does not fall below a lower operating pressure p₁ which in practice lies around 10% above p₀. Recuperation must be terminated at the latest at p₁, so that thereafter the conventional drive of the vehicle must provide the drive moment or drive energy. Similarly the pressure p which increases on charging with pressure medium, or the lower operating pressure p₁ in the store 2, can be limited via the control device 36.

FIG. 2 shows an extract from a hydraulic circuit diagram of a second embodiment example of the traction drive according to the invention. For reasons of clarity only the differences from the embodiment example in FIG. 1 are described. The situations outlined in connection with the first embodiment example (see FIG. 1) for regenerative braking and acceleration apply similarly in the second embodiment example.

In contrast to the first embodiment example according to FIG. 1, the second embodiment example according to FIG. 2 allows the pressure p in the store 2 or the corresponding gas pretension pressure p₀ to be increased using the hydraulic energy stored in the pressure medium of the store 2. This therefore takes place regeneratively. For this, connected to the hydraulic high-pressure line 8 between the shut-off valve 12 and the store 2 is a further hydraulic high-pressure line 150 which in turn is connected to a high-pressure connection of a hydraulic motor 152. The hydraulic motor 152 is coupled to the pump 24. In the hydraulic high-pressure line 150 between the line 8 and the hydraulic motor 152 is arranged a 2/2-way shut-off valve 154 which is connected via a signal line 155 with the control device 36.

If now the pressure p or its corresponding gas pretension pressure p₀ is increased, this takes place—as in the first embodiment example according to FIG. 1—via the pump 24. In the second embodiment example described here according to FIG. 2, the pump 24 is however driven via the hydraulic motor 152 which draws its drive energy via the high-pressure line 150 from the braking energy already previously stored regeneratively in this store 2. For this the shut-off valve 34 is closed via the control device 36, the 2/2-way shut-off valve 154 is opened accordingly. The hydraulic motor 152 then expands the pressure medium, flowing in via the line 150, via a hydraulic low-pressure line 156 into a tank 20.

FIG. 3 shows an extract from a hydraulic circuit diagram of a second embodiment example of the traction drive according to the invention with an alternative compressor unit. A pressure booster 270 here replaces the pump 24 shown in the previous embodiment examples (see FIGS. 1 and 2) to compress the gas to the necessary pressure p. The gas is compressed, as in the second embodiment example in FIG. 2, using the hydraulic energy stored in the pressure medium of the store 2 and hence regeneratively.

The pressure booster 270 has a hydraulic chamber 272 which is connected via a hydraulic line 274 to a 3/2-way valve 276 which can connect the hydraulic line 274 either with a hydraulic high-pressure line 208 or with a tank 280. The pressure booster 270 also has a gas chamber 273 which is connected via a pneumatic line 275 to a 3/2-way valve 277 which can connect the pneumatic line 275 either with a hydraulic high-pressure line 222 or with a gas tank 281. The hydraulic chamber 272 is isolated from the gas chamber 273 via a stepped piston 282. Its piston area at the hydraulic chamber 272 is here greater than its piston area at the gas chamber 273.

A valve setting of the 3/2-way valve 277 is coupled via a signal line 284 to the valve setting of the 3/2-way valve 276. The control device 36 is connected with the 3/2-way valve 276 via a signal line 286.

If the gas in the gas chamber 4 of the store 2 is to be compressed and its pressure p increased, first the gas chamber 273 must be filled with gas and the hydraulic chamber 272 evacuated. For this the control device 36 controls the valve 276 via the signal line 286 so that the valve 276 connects the hydraulic line 274 with the tank 280. The valve setting of the 3/2-way valve 277 is controlled via the signal line 284 such that here the pneumatic line 275 is connected with the gas tank 281. The gas tank 281 has a suitable pretension so that the pressure acting in the gas chamber 273 displaces the stepped piston 282 from right to left in FIG. 3. The gas chamber 273 is thus filled. At the same time the stepped piston 282 pushes the pressure medium in the hydraulic chamber into the pressureless tank 280.

To compress the gas, the control device 36 controls the valve 276 via the signal line 286 such that the valve 276 connects the hydraulic line 274 with the hydraulic high-pressure line 208 and the valve 277 connects the pneumatic line 275 with the pneumatic high-pressure line 222. Thus firstly pressure medium under high pressure flows out of the pressure medium 6 of the store 2 into the hydraulic chamber 272 and hence pushes the stepped piston 282 (in FIG. 3) from left to right, and secondly gas is expelled from the reducing gas chamber 273 and delivered into the gas chamber 4 of the store 2.

The gas is compressed and the store 2 thus filled in the cyclic work described of the stepped piston 282 until the required pressure p is reached in the store 2. Then the control device 36 controls valves 276 and 277 into the position shown in FIG. 3.

A drive is disclosed with a hydrostatic energy store which can be charged via a hydromachine for converting kinetic energy into hydraulic energy, wherein the drive has a control device via which a preload of the store can be controlled as a function of an operating state of a device driven by the drive.

Furthermore a hydrostatic energy store is disclosed for a drive of a device, in particular for a traction drive of a vehicle, wherein the store has a hydromachine which converts kinetic energy into hydraulic energy and via which the store can be charged, and wherein the store has a control device via which a preload of the store can be changed as a function of an operating state of the device.

A method is also disclosed for adapting a preload of a hydrostatic energy store of a drive of a device, in particular a traction drive of a vehicle, which comprises the steps of determining an operating state of the device, determining the optimum preload as a function of the operating state determined, setting the preload, wherein at least the step of setting is controlled by a control device.

1. A drive, comprising:
a hydromachine configured to convert kinetic energy into hydraulic energy,
a hydrostatic energy store configured to be charged via the hydromachine, and
a control device configured to change a preload of the hydrostatic energy store as a function of an operating state of a device driven by the drive.

2. The drive as claimed in claim 1, wherein the hydrostatic energy store is configured to be discharged via the hydromachine.

3. The drive as claimed in claim 1, wherein a change of a pressure of a compressible fluid or gas arranged in a gas chamber of the hydrostatic energy store changes the preload.

4. The drive as claimed in claim 1, wherein the hydrostatic energy store is connected via a hydraulic high-pressure line to a working line of a hydraulic circuit of the drive, and wherein a shut-off valve is arranged in the hydraulic high-pressure line.

5. The drive as claimed in claim 3, wherein the control device is connected with a pressure sensor configured to determine the pressure of the fluid or gas.

6. The drive as claimed in claim 3, wherein a compressor unit is configured to increase the pressure of the fluid or gas.

7. The drive as claimed in claim 3, wherein a pressure-relief unit is configured to reduce the pressure of the fluid or gas.

8. The drive as claimed in claim 6, wherein the compressor unit has a pump which is connected via a pneumatic low-pressure line with a gas tank and via a pneumatic high-pressure line with a gas chamber of the hydrostatic energy store.

9. The drive as claimed in claim 7, wherein the pressure-relief unit has a shut-off valve which is connected via a pneumatic low-pressure line with a gas tank and via a pneumatic high-pressure line with the gas chamber of the hydrostatic energy store.

10. The drive as claimed in claim 4, wherein the control device is connected with the shut-off valve of the hydraulic high-pressure line or with the hydromachine.

11. (canceled)

12. (canceled)

13. The drive as claimed in claim 6, wherein the compressor unit has a hydropneumatic pressure booster, wherein a hydraulic chamber of the pressure booster is configured to be connected via a 3/2-way valve with a tank or with a hydraulic high-pressure line of the hydrostatic energy store, and wherein a gas chamber of the pressure booster can is configured to be connected via a 3/2-way valve with a gas tank or with a pneumatic high-pressure line of the hydrostatic energy store.

14. A hydrostatic energy store for a drive of a device, comprising:
a hydromachine via which kinetic energy is configured to be converted into hydraulic energy and via which the hydrostatic energy store is configured to be charged, and
a control device configured to change a preload of the hydrostatic energy store as a function of an operating state of the device.

15. A method for adapting a preload of a hydrostatic energy store of a drive of a device, comprising:
determining an operating state of the device;
determining an optimum preload as a function of the operating state determined; and
setting the; preload,
wherein at least the setting of the preload is controlled via a control device.

16. The drive as claimed in claim 7, wherein the control device is connected with the shut-off valve of the pressure relief unit.

17. The drive as claimed in claim 8, wherein the control device is connected with a drive of the pump.

18. The drive as claimed in claim 17, wherein the drive of the pump is a hydraulic motor which has a high-pressure connection connected with the hydraulic high-pressure line.

19. The drive as claimed in claim 18, wherein a shut-off valve configured to be controlled by the control device is arranged in a line connecting the hydraulic motor and the hydraulic high-pressure line.

20. The hydrostatic energy store as claimed in claim 14, wherein the drive is a traction drive of a vehicle.
